(19) United States
(12) Patent Application Publication
(10) Pub. No.: US 2025/0241249 A1
(43) Pub. Date: Jul. 31, 2025

(54) DEHUMIDIFIER SYSTEMS AND ASSEMBLIES

(71) Applicant: MUCLITECH INC., Montreal (CA)

(72) Inventor: Jason LESIEGE, St-Sauveur (CA)

(21) Appl. No.: 18/853,955

(22) PCT Filed: Apr. 3, 2023
(86) PCT No.: PCT/CA2023/050449

§ 371 Date: Oct. 3, 2024

Related U.S. Application Data
(60) Provisional application No. 63/327,475, filed on Apr. 5, 2022.

(51) Int. Cl. A01G 9/24; B33Y 80/00; F24F 3/14; F24F 13/20

(52) U.S. Cl. CPC A01G 9/246; F24F 3/14; F24F 13/20; B33Y 80/00

(57) ABSTRACT

A dehumidifying system and dehumidifier assemblies for humidity management in an interior environment. The system includes a plurality of dehumidifier assemblies, each dehumidifier assembly including a housing defining air inlets and outlets; a heat exchange core defining therein a first airflow path fluidly connected to the air inlets, and a second airflow path fluidly connected to the air outlet; and a water spray system disposed at least partially in the housing. The water spray system is arranged for delivering water droplets downstream of the first airflow path for causing condensation of moisture from air flowing from the first airflow path when the assembly is in use and is configured for fluidly connecting to a cold-water supply. The housing and the heat exchange core is arranged such that air downstream of the water spray system flows into an input end of the second airflow path.

### CROSS-REFERENCE

The present application claims priority to U.S. Provisional Patent Application No. 63/327,475, entitled “Dehumidifier Systems and Assemblies,” filed Apr. 5, 2022, the entirety of which is incorporated by reference herein.

### FIELD OF TECHNOLOGY

The present technology relates generally to dehumidifiers, and more specifically to dehumidifier systems and assemblies for interior environments.

### BACKGROUND

Various climate management strategies and systems are known for maintaining air quality and/or managing humidity for the comfort of people in interior spaces. These include, inter alia, opening windows, use of air exchangers, and use of humidifiers or dehumidifiers. Such standard HVAC systems are generally designed around temperatures and humidity levels considered comfortable for daily human activity. When designing climate control systems for uses where desired temperatures and humidity levels are different from typical HVAC requirements, for example for greenhouses, different solutions are required.

One standard practice for managing humidity, especially in semi-closed environments like greenhouses, is to open windows or louvers to an exterior of the environment to allow humid air to flow out and drier air to flow in. In cool or colder climate regions, the drier air could be colder or much colder than the humid air flowing out. When employing such a solution, the overall temperature of the interior environment will drop when exchanging air to reduce humidity. Additional heating is thus subsequently needed to return the interior environment to the desired temperature conditions, thereby increasing energy consumption and costs.

U.S. Pat. No. 9,140,396, issued Sep. 22, 2015, presents another solution to humidity and climate management. A dehumidification apparatus is disclosed which uses a cooled core coupled to an external cooling source, providing a coolant fluid circulating through the cooled core. While the issue of losing heated air to an exterior is avoided, the solution requires the use of a coolant fluid in a refrigerant arrangement to cool air to induce condensation. In such refrigerant systems, the coolant fluids may evaporate, to the detriment of the environment. Large heat exchange apparatuses are also often need in order to cool the coolant fluid, often requiring substantial energy to run and occupying a large area floor area of the environment.

Therefore, there remains a desire for solutions for managing humidity for interior environments.

### SUMMARY

It is an object of the present technology to ameliorate at least some of the inconveniences present in the prior art.

According to aspects of the present technology, a dehumidifier system is presented for managing humidity in an interior space, such as a semi-closed or closed environment. The system includes a centralized cold water supply, one or more dehumidifier assemblies, and a water collection system fluidly connected to the assemblies. Each dehumidifier assembly includes a heat exchange core and a water spray system receiving cold water from the cold water supply. Air circulating through the assembly is cooled by the core, sprayed with cold water to induce condensation, and then rewarmed by flowing back through the core (heat warming the outgoing air flowing from and thus cooling the incoming air). Water condensed from the air is then collected by the water collection system, where it can be sent to a drain, returned to the cold water supply, and/or provided to plants or other installations in the environment. In some case, the water spray further acts to aid in filtering the air in a process generally known as “air washing.”

By centralizing the cold water supply and the water collection system, relatively small and low cost dehumidifier assemblies can be installed at different desired points throughout the interior environment. By having the capability of having multiple different locations of air treatment by the assemblies, the system can provide more efficient dehumidification across the interior environment. In some cases, the assemblies can be controlled individually or in subgroups to provide local humidity control in different zones of the interior environment, also referred to herein as microclimates. In at least some embodiments, the heat exchange core, the assembly housing, and/or the water collection system can be fabricated using additive manufacturing (separately or in a integrally connected unit).

According to one aspect of the present technology, there is provided a dehumidifier assembly for humidity management in an interior environment. The assembly includes a housing defining at least one air inlet and at least one air outlet; a heat exchange core disposed at least partially in the housing, the heat exchange core defining therein: a first airflow path fluidly connected to the at least one air inlet at an input end of the first airflow path, and a second airflow path fluidly connected to the at least one air outlet at an output end of the second airflow path; and a water spray system disposed at least partially in the housing, the water spray system being configured to be fluidly connected to a cold water supply, the water spray system being arranged for delivering water droplets at least partially downstream of an output end of the first airflow path for causing condensation of moisture from air flowing from the first airflow path when the assembly is in use, the housing and the heat exchange core being arranged such that at least some air downstream of the water spray system flows into an input end of the second airflow path.

In some embodiments, the heat exchange core is formed by additive manufacturing.

In some embodiments, the heat exchange core has a cellular counter-flow geometry; the first airflow path is formed by a first plurality of passages defined through the heat exchange core; and the second airflow path is formed by a second plurality of passages defined through the heat exchange core.

In some embodiments, the housing is configured to be connected to a water collection system to remove water from housing.

In some embodiments, the housing defines at least one opening in a lower portion of the housing, the at least one opening being arranged to be fluidly connected to the water collection system.

In some embodiments, the water spray system includes at least one spray nozzle disposed at least partially in the housing.

In some embodiments, the housing includes at least one separating wall extending generally vertically through a portion of the housing; the air outlet of the first airflow path and the at least one spray nozzle are disposed on a first side of the at least one separating wall; and the air inlet of the second airflow path is disposed on a second side of the at least one separating wall.

In some embodiments, the dehumidifier assembly further includes a fan disposed in the housing, the fan being arranged to draw air from an interior of the housing from the second airflow path when in use.

In some embodiments, the housing, the heat exchange core, and the water spray system are arranged such that, when the apparatus is in use: warm, humid air flows into the at least one air inlet and into the first airflow path, heat being transferred from air flowing through the first airflow path to air flowing through the second airflow path thereby cooling air flowing through the first airflow path; cooled, humid air flows out of the first airflow path and is impacted by mist projected from water spray system, the mist further cooling air flowing past the water spray system and inducing condensation of humidity from said air; cooled, dehumidified air flows into the input end of the second airflow path to flow through the heat exchange core, air flowing through the second airflow path receiving heat from air flowing through the first airflow path via the heat exchange core; and re-warmed, dehumidified air flows out of the at least one air outlet of the housing.

In some embodiments, at least a majority of the heat exchange core is disposed vertically above the water spray system.

In some embodiments, the heat exchange core is a first heat exchange core disposed in an upper portion of the housing; and the first heat exchange is disposed vertically above the water spray system; and further including a second heat exchange core disposed in a lower portion of the housing, the second heat exchange being disposed below the water spray system.

According to another aspect of the present technology, there is provided a dehumidifying system for humidity management in an interior environment. The system includes a plurality of dehumidifier assemblies, each dehumidifier assembly including a housing defining at least one air inlet and at least one air outlet; a heat exchange core disposed in the housing, the heat exchange core defining therein a first airflow path fluidly connected to the at least one air inlet at an input end of the first airflow path, and a second airflow path fluidly connected to the at least one air outlet at an output end of the second airflow path; and a water spray system disposed at least partially in the housing, the water spray system being arranged for delivering water droplets at least partially downstream of an output end of the first airflow path for causing condensation of moisture from air flowing from the first airflow path when the assembly is in use, the water spray system being configured for fluidly connecting to a cold water supply, the housing and the heat exchange core being arranged such that at least some air downstream of the water spray system flows into an input end of the second airflow path; and a water collection system fluidly connected to each dehumidifier assembly for receiving water from each dehumidifier assembly.

In some embodiments, the dehumidifying system further includes the cold-water supply fluidly connected to the water spray system of each dehumidifier assembly.

In some embodiments, the cold-water supply includes a water reservoir; and a pump fluidly connected to the water reservoir and the water spray system of each dehumidifier assembly.

In some embodiments, the dehumidifying system further includes a chiller unit operatively connected to the water reservoir for cooling water in the water reservoir during operation of the system.

In some embodiments, the chiller unit is disposed on an exterior of the interior environment.

In some embodiments, the water collection system is fluidly connected to the water reservoir, such that water collected from the plurality of dehumidifier assemblies is provided to the cold-water supply for reuse during operation of the system.

In some embodiments, the system is arranged to deliver water collected by the water collection system to at least one planting structure.

In some embodiments, the water collection system is formed from a plurality of rigid tubes.

In some embodiments, the plurality of rigid tubes is formed by additive manufacturing.

In some embodiments, the dehumidifying system further includes a water filter fluidly connected to the water collection system for filtering collected water.

According to yet another aspect of the present technology, there is provided a dehumidifier structure for humidity management in an interior environment, the assembly comprising a container; a dehumidifier assembly partially disposed in the container, the dehumidifier assembly comprising: a housing defining at least one air inlet and at least one air outlet; and a heat exchange core disposed at least partially in the housing, the heat exchange core defining therein: a first airflow path fluidly connected to the at least one air inlet at an input end of the first airflow path, and a second airflow path fluidly connected to the at least one air outlet at an output end of the second airflow path; and a water spray system disposed at least partially in the container, the water spray system being configured to be fluidly connected to a cold water supply, the water spray system being arranged for delivering water droplets at least partially downstream of an output end of the first airflow path for causing condensation of moisture from air flowing from the first airflow path when the assembly is in use, the housing and the heat exchange core being arranged such that at least some air downstream of the water spray system flows into an input end of the second airflow path.

In some embodiments, the heat exchange core is formed by additive manufacturing.

In some embodiments, the heat exchange core has a cellular counter-flow geometry; the first airflow path is formed by a first plurality of passages defined through the heat exchange core; and the second airflow path is formed by a second plurality of passages defined through the heat exchange core.

In some embodiments, the container is configured to be connected to a water collection system to remove water from housing.

In some embodiments, the water spray system comprises at least one spray nozzle disposed at least partially in the container.

In some embodiments, the dehumidifier structure further includes at least one fan disposed in the housing, the fan being arranged to draw air from an interior of the container into the second airflow path when in use.

In some embodiments, the container, the housing, the heat exchange core, and the water spray system are arranged such that, when the apparatus is in use: warm, humid air flows into the at least one air inlet and into the first airflow path, heat being transferred from air flowing through the first airflow path to air flowing through the second airflow path thereby cooling air flowing through the first airflow path; cooled, humid air flows out of the first airflow path and is impacted by mist projected from water spray system, the mist further cooling air flowing past the water spray system and inducing condensation of humidity from said air; cooled, dehumidified air flows into the input end of the second airflow path to flow through the heat exchange core, air flowing through the second airflow path receiving heat from air flowing through the first airflow path via the heat exchange core; and re-warmed, dehumidified air flows out of the at least one air outlet of the housing.

According to yet another aspect of the present technology, there is provided a dehumidifier system including at least one dehumidifier structure according to any of the above embodiments, and at least one water collection structure fluidly connected to the water collection structure.

As used herein, the term “about” in the context of a given value or range refers to a value or range that is within 20%, preferably within 10%, and more preferably within 5% of the given value or range.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view of an interior environment having a dehumidifying system, according to a non-limiting embodiment of the present technology, installed therein;

FIG. 2 is a schematic diagram of the environment and the dehumidifying system of FIG. 1;

FIG. 3 is a schematic diagram of the environment of FIG. 1, having a dehumidifying system, according to another non-limiting embodiment of the present technology, installed therein;

FIG. 4 is a perspective view of a dehumidifier assembly of the dehumidifying system of FIG. 1;

FIG. 5 is a schematic diagram of the dehumidifier assembly of FIG. 4;

FIG. 6 is a partially cut-away, cross-sectional view of the dehumidifier assembly of FIG. 4;

FIG. 7 is a partial, exploded view of an upper portion of the dehumidifier assembly of FIG. 4;

FIG. 8 is a perspective view of a heat exchange core of the dehumidifier assembly of FIG. 4;

FIG. 9 is a top plan view of the heat exchange core of FIG. 8;

FIG. 10 is a schematic diagram of a dehumidifier assembly according to another non-limiting embodiment of the present technology;

FIG. 11 is a schematic diagram of a dehumidifier assembly according to yet another non-limiting embodiment of the present technology;

FIG. 12A is a schematic side elevation view of the environment and dehumidifying system of FIG. 1;

FIG. 12B is a schematic top plan view of the environment and dehumidifying system of FIG. 1;

FIG. 13A is a schematic side elevation view of an environment and a dehumidifying system according to another non-limiting embodiment;

FIG. 13B is a schematic top plan view of the environment and dehumidifying system of FIG. 13A;

FIG. 14 is a perspective view of a dehumidifier system according to yet another non-limiting embodiment of the present technology;

FIG. 15 is a side elevation view of the dehumidifier system of FIG. 14;

FIG. 16 is a perspective view of a dehumidifier structure of the dehumidifier system of FIG. 14;

FIG. 17 is another perspective view of the dehumidifier structure of FIG. 16;

FIG. 18 is a cross-sectional view of the dehumidifier structure of FIG. 16, taken along line 18-18 of FIG. 17;

FIG. 19 is a perspective view of a dehumidifier assembly of the dehumidifier structure of FIG. 16;

FIG. 20 is a side elevation view of the dehumidifier assembly of FIG. 19, with a container of the dehumidifier structure being illustrated schematically;

FIG. 21 is a cross-sectional view of the dehumidifier assembly and the schematic container of FIG. 20, taken along line 21-21 of FIG. 20;

FIG. 22 is a perspective view of a heat exchanger core of the dehumidifier assembly of FIG. 19; and

FIG. 23 is the cross-sectional view of the dehumidifier assembly and the schematic container of FIG. 21, with an alternative air flow pattern illustrated.

Unless otherwise noted, figures may not be drawn to scale.

### DETAILED DESCRIPTION

Although the present technology is described below mainly with respect to use within a semi-closed environment, specifically a greenhouse, it is contemplated that aspects could be applied to other interior environments, including but not limited to semi-closed or to closed environments. The systems described herein could be implemented in a variety of interior spaces, including but not limited to: laboratory or research environments requiring humidity management; materials, alimentation, and/or industrial processing facilities; habitable spaces requiring additional or alternative humidity management; and facilities requiring air filtering in addition to humidity management.

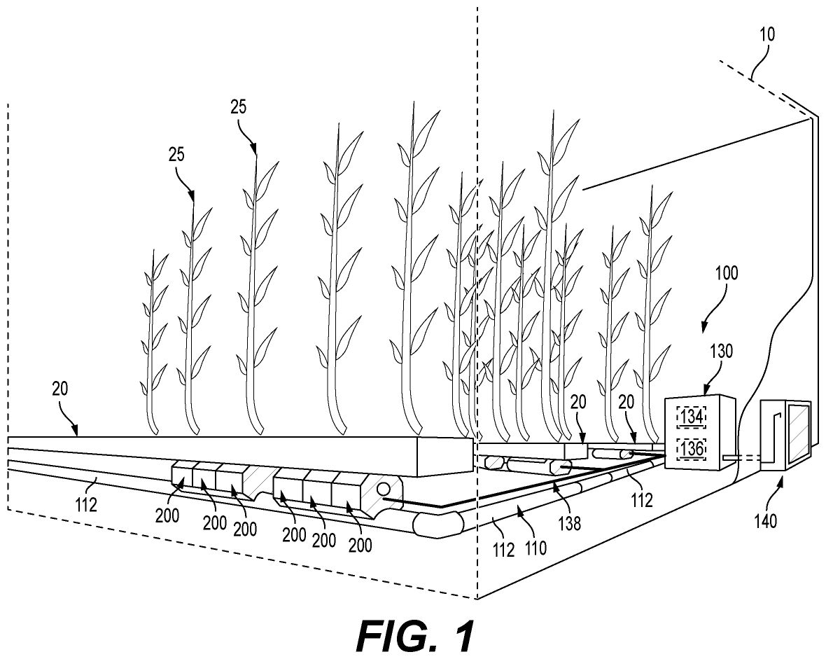

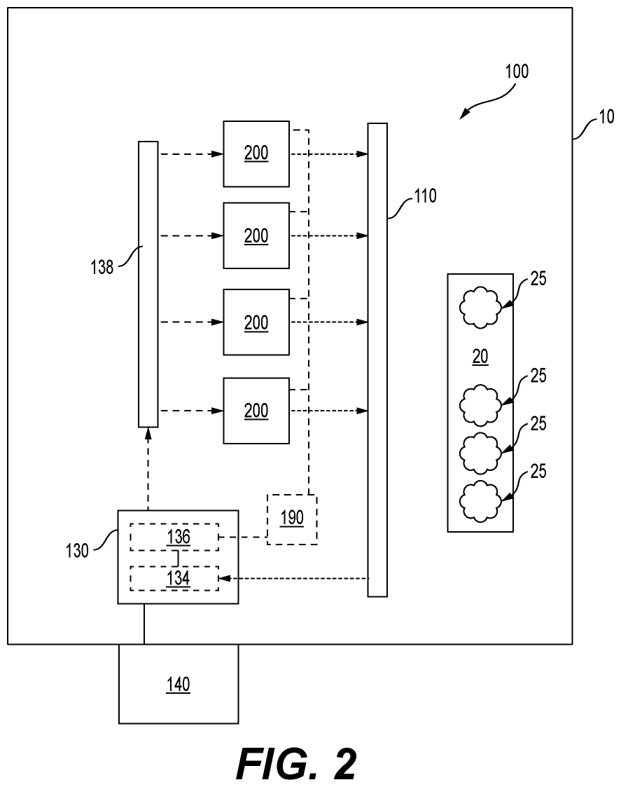

With reference to FIGS. 1 and 2, a dehumidifying system 100 according to one non-limiting embodiment of the present technology is illustrated. The dehumidifying system 100 is shown in use in a semi-closed environment 10 in FIG. 1, specifically a semi-closed greenhouse environment 10. Components of the dehumidifying system 100 are set out here; operation of the system 100 is described in greater detail below.

The dehumidifying system 100 includes a plurality of dehumidifying assemblies 200. The exact number of dehumidifying assemblies 200 provided in a given dehumidifying system 100 will vary for different embodiments of the system 100. It is contemplated that some embodiments could include as few as just a single dehumidifier assembly 200 and could include many assemblies 200 without a specific limit depending on the size and needs of a particular environment in which the system 100 is installed. Each dehumidifier assembly 200 is configured to draw in warm humid air, cool and remove moisture from the air, and then reheat the dried air in order to output dryer, warm air back into the environment 10. Specifics of the dehumidifying assemblies 200 will be described in more detail below.

The dehumidifying system 100 also includes a water collection system 110 for collecting water extracted from the air by the dehumidifying assemblies 200. In the illustrated example, the water collection system 110 is formed from a series of connected rigid tubes 112. The present tubes 112 are formed by additive manufacturing (also known as 3D printing). The tubes 112, as well as other components described herein being formed from additive manufacturing, are generally formed from polylactic acid (PLA), although it is contemplated that a variety of materials could be used, including by not limited to: glycol-modified polyethylene terephthalate (PETG), recycled plastics, and, in some cases, metal composites configured for additive manufacturing, such as stainless steel, copper, and titanium. It is contemplated that the full structure of the water collection system 110 could be formed in one integrally connected piece using additive manufacturing. In some embodiments, the rigid tubing 112 could be formed from off the shelf piping components, for example PVC piping. It is also contemplated that the system 110 could be formed in part or in whole by flexible tubing. In at least some embodiments, the assemblies 200 could be connected directly together such that at least a portion of the tubing 112 could be omitted. It is also contemplated that the assemblies 200 could be fluidly connected to a drainage system present in the environment 10. For example, water could be allowed to drain from the assemblies 200 into drains defined in a flow of the environment 10, with the rigid tubing 112 being omitted.

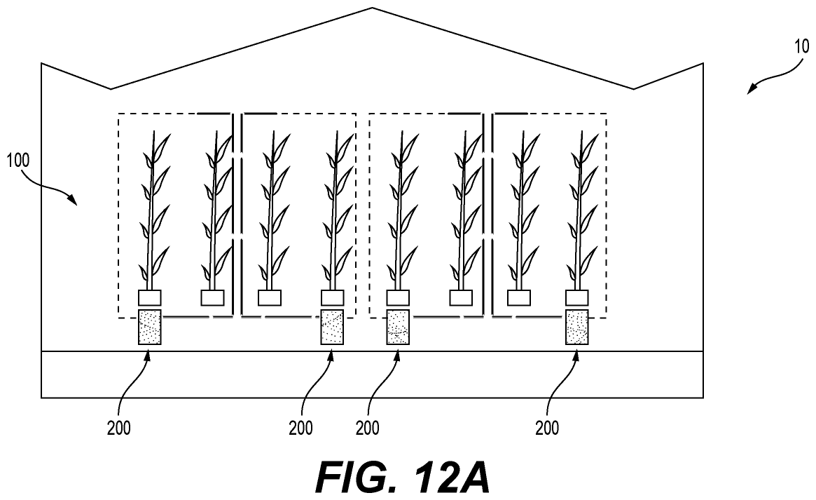

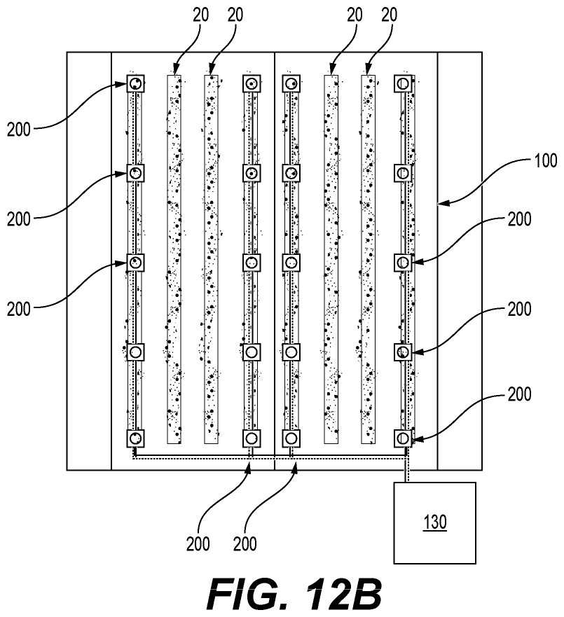

Each assembly 200 is fluidly connected to the water collection system 110, as will be described further below. While the assemblies 200 and the water collection system 110 are arranged in straight rows generally aligned with walls of the greenhouse 10 (see also FIGS. 12A,B), it is contemplated that the assemblies 200 and the water collection system 110 could be arranged in any number of forms or distributions. By forming the water collection system 110 using additive manufacturing, the distribution of tubes 112 and the assemblies 200 through an interior space could be adapted on a case-by-case basis. Some non-limiting examples of arrangements possible in the present technology include but are not limited to: vertical stacking along walls of the interior environment, assemblies 200 disposed around or along columns in the interior environment, and/or attaching assemblies 200 to the ceiling.

As is illustrated schematically, the dehumidifying system 100 also includes a controller 190 communicatively connected to the plurality of dehumidifier assemblies 200. The controller 190 is a computer-implemented device for receiving information from the assemblies 200 related to local climate conditions within the greenhouse 10, as will be described in more detail below. The specific form of the controller 190 is not particularly limited. It is contemplated, for example, that a user device such as a tablet or smart phone could be used to implement the controller 190, the user device being wirelessly connected to one or more of the components of the system 100.

The dehumidifying system 100 further includes a cold-water supply 130 fluidly connected to the dehumidifying assemblies 200. When the dehumidifying system 100 is in operation, the cold-water supply 130 provides cold water to each of the dehumidifying assemblies 200. As will be described in more detail below, each dehumidifying assembly 200 uses a cold-water spray to cause condensation of humidity in the air flowing through the assembly 200. For purposes of the present description, “cold water” is meant to refer to water in temperatures generally ranging from about 0° C. to about 18° C., and more preferably from about 4° C. to about 10° C. Depending on the particular embodiment or use, exact water temperatures could vary from greater than 0 degrees Celsius up to a dew point for the particular embodiment and operational situation.

In the illustrated embodiment, the supply 130 includes a water reservoir 134 (shown schematically) for storing water therein. The supply 130 also includes a pump 136 fluidly connected to the water reservoir 134. The pump 136 is further fluidly connected to a water spray system 260 (described further below) of each dehumidifier assembly 200. In the illustrated embodiment, the pump 136 is connected to the water spray systems 260 via a rigid water delivery structure 138. The pump 136 is communicatively connected to the controller 190, such that the controller 190 can control activation of the pump 136 in order to cause, or stop, water delivery to the assemblies 200. In some embodiments, it is contemplated that the cold-water supply 130 could further include one or more valves, for example to control water flow to one or more subgroups of dehumidifier assemblies 200. Additional components for monitoring and/or managing water flow could be included in different embodiments, including but not limited to flow meters, pressure meters, and temperature sensors.

The water delivery structure 138 is formed from a series of rigid tubes formed by additive manufacturing. It is contemplated that the structure 138 could be insulated by applying an insulating material around an exterior of the structure 138. It is also contemplated that at least one layer of insulating material could be formed with the structure 138 during the additive manufacturing fabrication process to aid in maintaining the temperature of the water flowing therethrough. In at least some cases, the rigid tubing 112 of the water collection system 110 and/or the housing 210 could also be insulated or formed with insulating material. In some embodiments, it is contemplated that the cold-water supply 130 could be connected to the assemblies 200 via flexible tubing, for example by hoses. In some other embodiments, it is contemplated that the water delivery structure 138 could be integrally formed with the water collection system 110, such that one rigid structure connects to the assemblies 200.

In the illustrated embodiment of FIGS. 1 and 2, the water reservoir 134 is fluidly connected to the water collection system 110 in order to recuperate the collected water by the collection system 110 for reuse by the cold-water supply 130. In this way, water usage and waste can be decreased in some cases. It is also contemplated that the water reservoir 134 and/or the cold-water supply 130 could be implemented by water infrastructure available in the environment (discussed below). While the water collection system 110 is arranged to use gravity to direct collected water toward the water reservoir 134, it is contemplated that one or more pumps could be included in the water collection system 110 for pump water through the system 110.

The dehumidifier system 100 further includes a chiller unit 140 operatively connected to the cold-water supply 130. In the illustrated example, the chiller unit 140 is a heat pump cooler 140 disposed on an exterior of the greenhouse 10. The heat pump cooler 140 is thermally connected to the water reservoir 134 in order to expel heat from water in the reservoir 134 outside the greenhouse 10, thus cooling the water in the water reservoir 134. In at least some embodiments, the chiller unit 140 could be implemented using a conventional refrigerant chiller (i.e. a refrigeration unit). In such an embodiment, the chiller unit could be disposed inside of or exterior to the greenhouse 10. In at least some embodiments, the chiller unit 140 could further be configured to control and adjust the water temperature of water in the reservoir 134. In such a case, for example, the controller 190 could be communicatively connected to a temperature monitor in the reservoir 134 and to the chiller unit 140 in order to manage and adjust the water temperature of the cold-water supply 130.

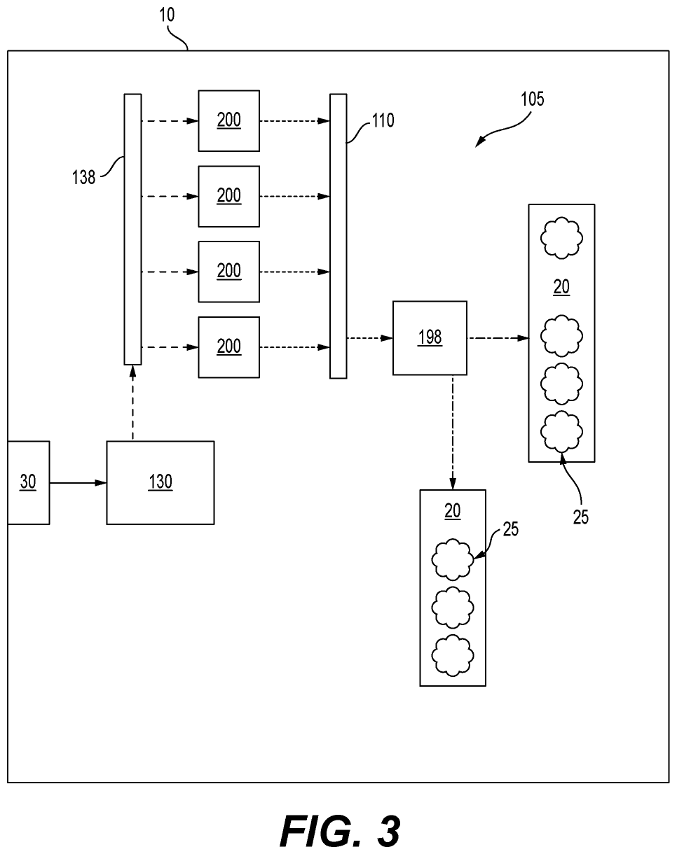

With reference to FIG. 3, another non-limiting embodiment of a dehumidifying system 105 is illustrated. Elements of the dehumidifying system 105 that are similar to those of the dehumidifying system 100 retain the same reference numeral and will generally not be described again.

The dehumidifying system 105 further includes a filter 198 for filtering collected water from the dehumidifier assemblies 200. The filter 198 is fluidly connected to the water collection system 110. As is illustrated schematically, the system 105 is arranged to deliver by tube (not shown) the filtered, collected water to one or more of the planting structures 20 in order to use the collected water for watering the plants 25. By forming the assemblies 200, the delivery structure 138, and the tubes 112 from generally plant-safe, nontoxic plastics or 3D printed metal, rather than commonly used cost effect soldering compounds which often include heavy metals, the water can be supplied to the plants 25 generally without introduction of unnecessary pollutants. In at least some embodiments, it is also contemplated that the filtered water could be returned to the cold-water supply 130.

In the system 105, a modular cold-water supply has been omitted and an infrastructural cold-water supply 30, specifically a cold-water faucet 30, has been used. The cold-water faucet 30, available in the semi-closed environment, is fluidly connected to the delivery structure 138. Although not shown, it is contemplated that the system 105 could include additional components for controlling the flow of water from the faucet 30 to the delivery structure 138, including but not limited to valves and meters.

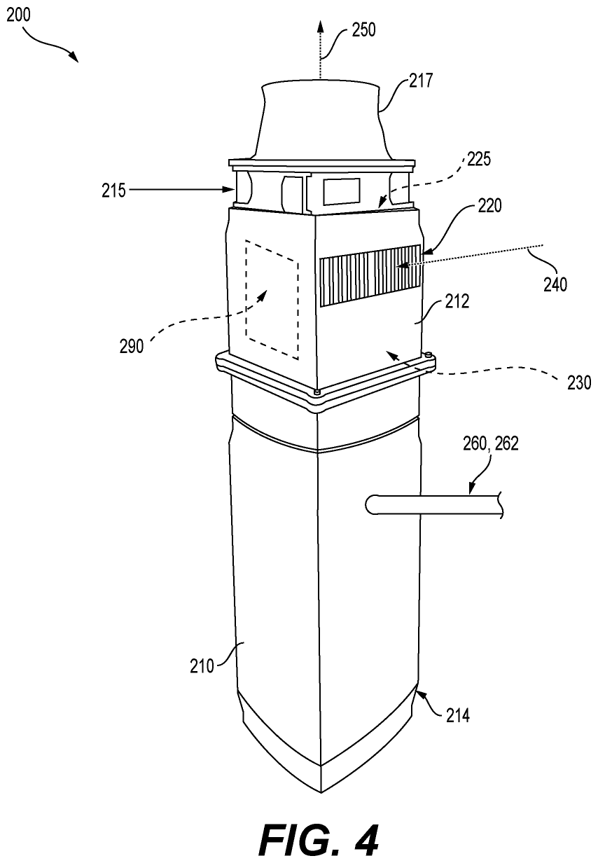

With reference to FIGS. 4 to 7, the dehumidifier assemblies 200 are described and illustrated in more detail. As the assemblies 200 are generally identical through the system 100, only one dehumidifier assembly 200, also referred to as the assembly 200, will be described.

The assembly 200 includes a housing 210, forming the overall shape and exterior of the assembly 200. In the illustrated embodiment, the housing 210 is formed from an upper portion 212 and a lower portion 214. The upper portions 212 and the lower portion 214 are fastened together, but it is contemplated that the portions 212, 214 could be connected together in different manners. It is also contemplated that the portions 212, 214 could be integrally formed in some embodiments.

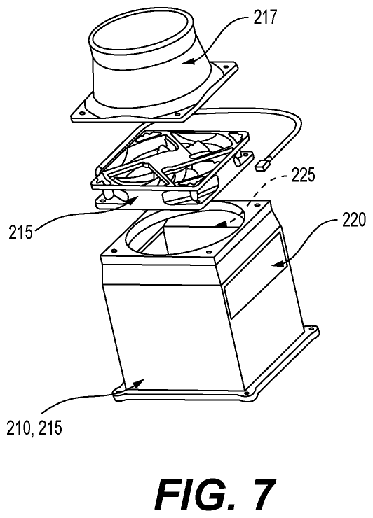

The housing 210 defines therein two oppositely disposed air inlets 220 for entry of air into the assembly 200 during operation. The inlets 220 are specifically formed in two lateral sides of the upper housing portion 212. The housing 210 also defines therein an air outlet 225. The outlet 225 is specifically formed in a top side in the upper housing portion 212 (see FIG. 7). In the illustrated embodiment, the assembly 200 further includes a fan 215 disposed over the air outlet 225 and a cone 217. The fan 215 is arranged to draw air out of the housing 210, in order to aid in initiation and operation of the assembly 200. Use of the fan 215 and the cone 217 will be further described below. In at least some embodiments, it is contemplated that the fan 215 and/or the cone 217 could be omitted. It is further contemplated that additional flaps, louvers, deflectors, and/or ducting could be included with the housing 210 in some embodiments. For example, ducting or deflectors could be included to selectively draw or emit air in a desired direction or position relative to the housing 210. It is also contemplated that the cone 217 could include flaps, louvers, and/or deflectors.

It is contemplated that in at least some embodiments, the relative positioning and number of inlet(s) 220 and outlet(s) 225 could be different. For example, the placement of inlets/outlets could be reversed, such that a different embodiment of a housing could include one air inlet in a top side of the housing and two laterally disposed air outlets. In some such embodiments, the fan 215 could further be configured to drive air into the assembly 200 through the inlet. Various other non-limiting arrangements of inlets and outlets are contemplated, depending on various implementational details of the given embodiment of the assembly 200. Similarly, placement of the fan 215 is not limited to the top side of the housing 210. For instance, one or more fans could be connected to lateral sides of the housing 210 to be aligned with inlets or outlets defined therein.

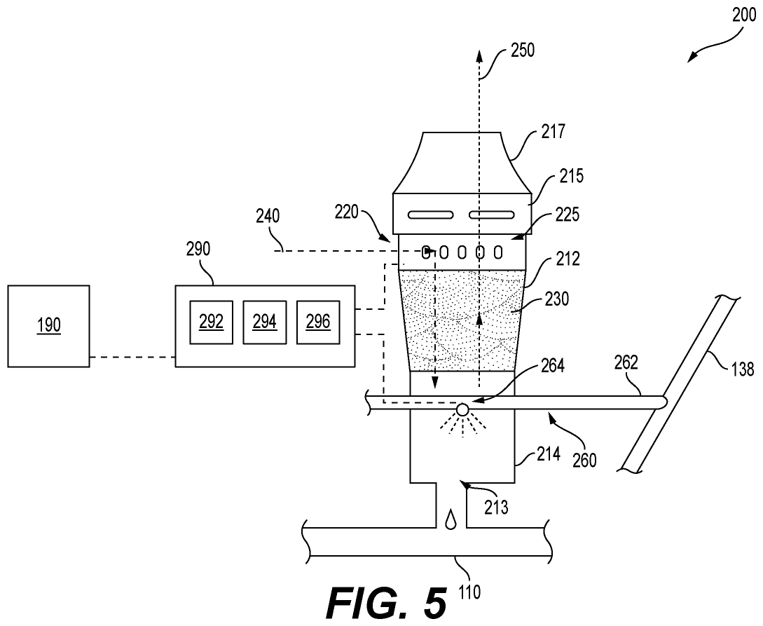

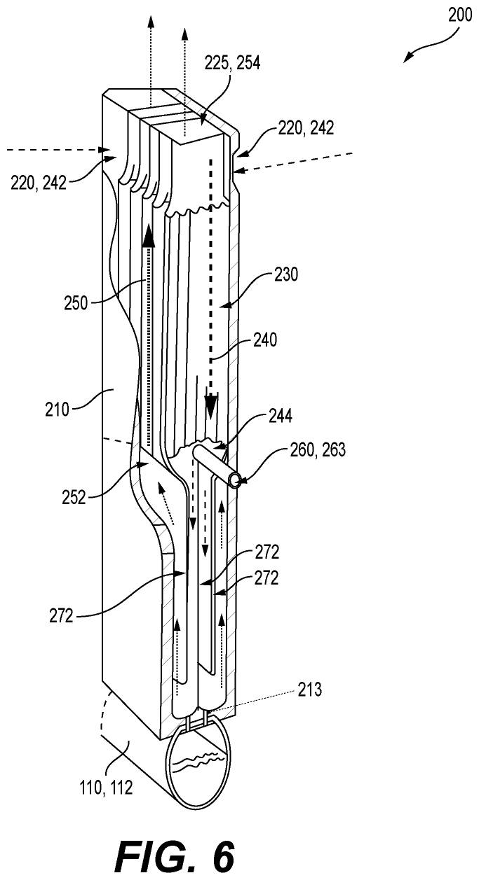

As is shown in FIG. 6 and schematically in FIG. 5, the housing 210 is connected to the water collection system 110 for removing water from housing 210. The housing 210 defines at least one opening 213 in the lower housing portion 214, specifically two openings 213 in the illustrated embodiment. The openings 213 are arranged to be fluidly connected to the water collection system 110, in the present embodiment by simply aligning the openings 213 with apertures (not shown) in one of the rigid tubes 112. In some cases, it is contemplated that the housing 210 or the lower housing portion 214 could be additively manufactured, and thus integrally connected, with a portion of rigid tubing 112 to connect to the water collection system 110. In some cases, it is contemplated that the housing 210 or the lower housing portion 214 could be additively manufactured with the water collection system 110 to form an integrally formed arrangement between the housing 210 and the water collection system 110.

The assembly 200 includes a heat exchange core 230, also referred to as a heat exchanger 230 or the core 230, disposed at least partially in the upper portion 212 of the housing 210. As will be described in more detail below, the heat exchange core 230 facilitates heat exchange between incoming and outgoing air from the assembly 200.

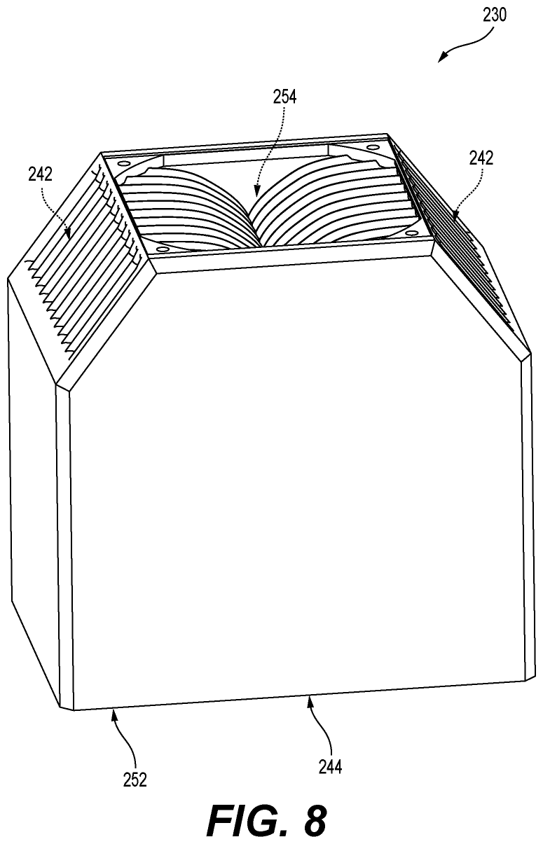

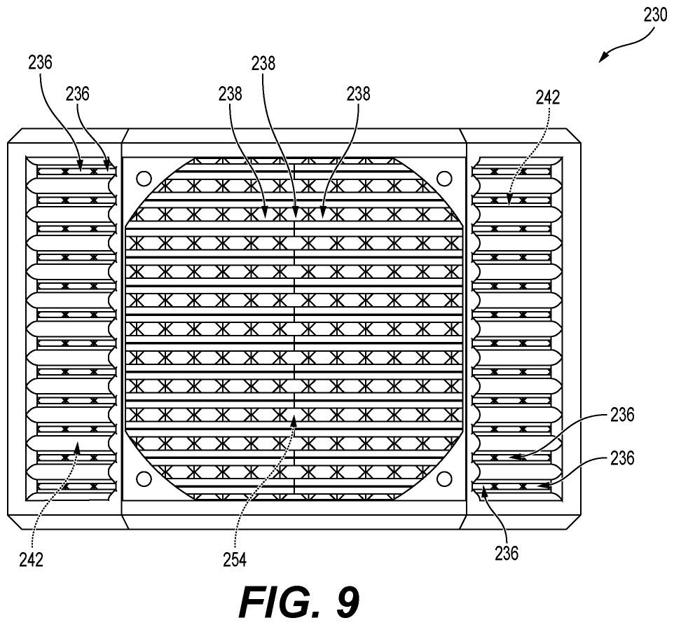

As can be seen in more detail in FIGS. 8 and 9, the heat exchange core 230 has a cellular counter-flow geometry, also referred to as cellular counter-current geometry. In the present embodiment, the heat exchange core 230 is formed by additive manufacturing. By using additive manufacturing, more complex geometries are accessible than would be available through standard milling or molding, allowing for high heat transfer efficiency designs to be realized and implemented in various embodiments of the assembly 200. In some embodiments, different geometries could be used for the heat exchanger, including but not limited to shapes derived or inspired by biomimetic models (e.g. human lung structures or plant root structures).

The core 230 defines therein two overall counter-flow arranged airflow paths. A first airflow path 240 directs air flowing from an exterior of the assembly 200, through one of the air inlets 220, into and through the core 230, and into a space inside the lower housing portion 214. A second airflow path 250 directs air flowing from the space inside the lower housing portion 214 into and through the core 230, and out of the assembly 200 via the air outlet 225. The first airflow path 240, also referred to as an incoming airflow path 240, is fluidly connected to the air inlet 220 at an input end 242 of the first airflow path 240. The second airflow path 250, also referred to as an outgoing airflow path 250, is fluidly connected to the air outlet 225 at an output end 254 of the second airflow path 250. The fan 215 is arranged to draw air from an interior of the housing 210 via the second airflow path 250 when in operation. Different fan and air flow arranged are additionally described below.

As the core 230 has a cellular counter-flow geometry with a plurality of passages for air flowing therethrough, the first airflow path 240 is formed by a first plurality of passages 236 defined through the heat exchange core 230 and the second airflow path 250 is formed by a second plurality of passages 238 defined through the core 230 (see FIG. 9).

While the housing 210 and the heat exchange core 230 are generally rectangular in the illustrated embodiments, this is simply one example and not meant to be limiting. While the housing 210 is generally shaped to fit close to the core 230, in order to avoid air passing around the core 230 rather than through the airflow paths 240, 250, the core 230 could be manufactured in a variety of forms.

The assembly 200 further includes a water spray system 260 disposed at least partially in a lower housing portion 214, illustrated schematically in FIG. 5. The water spray system 260 is fluidly connected to the cold-water supply 130. In the illustrated embodiment, the water spray system 260 includes a rigid tube 262 fluidly and integrally connected to the water delivery structure 138. The rigid tube 262 extends through the housing 210, although it is contemplated that the tube 262 could extend only partly into an interior of the housing 210.

The water spray system 260 is arranged for delivering water droplets at least partially downstream of an output end 244 of the first airflow path 240 for causing condensation of moisture from air flowing from the first airflow path 240 when the assembly 200 is in operation. The water spray system 260 includes at least one spray nozzle 264 disposed at least partially in the housing 210 for creating the water droplets. In the present embodiment, the nozzle 264 is specifically a vortex misting nozzle 264 disposed in a central position of the housing 210, vertically below the core 230. It is contemplated that different nozzle type or forms could be used in different embodiments. In some cases, more than one nozzle 264 could be included in the assembly 200. It is also contemplated that the tube 262 and/or one or more nozzles could be formed directly with the housing 210 during additive manufacturing.

In the illustrated embodiment, the nozzle 264 is positioned to project water droplets (also referred to herein as mist) in a generally downward direction, parallel (concurrent) to air flowing out of the first airflow path 240. In some embodiments, the nozzle 264 could be arranged to project water droplets antiparallel to air flow (a counter flow arrangement) and/or orthogonal to air flow (i.e. generally horizontal in the present configuration). The water spray system 260 and the nozzle 264 are configured to create water droplets in a range of about 50-micron diameter to about 100-micron diameter. In some embodiments, a different range of droplet sizes could be produced.

The housing 210 and the heat exchange core 230 are arranged such that at least some air downstream of the water spray system 260 flows into an input end 252 of the second airflow path 250. In order to aid in directing airflow around the water spray system 260, the housing 210 includes one or more separating walls 272 extending generally vertically through a portion of the housing 210.

In the illustrated embodiment, the lower housing portion 214 includes three walls 272 disposed generally below the water spray system 260 for aiding in directing airflow from the first airflow path 240 to the second airflow path 250. In at least some embodiments, the walls 272 further aid in impeding water droplets from coming back into contact with air flowing into the second airflow path 250. The air outlet 244 of the first airflow path 240 and spray nozzle 264 are disposed on an interior side of the two outward-most separating walls 272, while the air inlet 252 of the second airflow path 250 is disposed on an exterior side of the outward-most separating walls 272.

As is illustrated schematically in FIG. 5, each assembly 200 further includes a control board 290. The control board 290, in the present embodiment, is a circuit board disposed on a side of the housing 210, although it is contemplated that the sensing and management of the control board 290 could be provided by a different computer-implemented device. The control board 290 includes an air temperature sensor 292 for sensing the ambient air temperature at the given dehumidifier assembly 200. The control board 290 also includes an air humidity sensor 294 for sensing the ambient air humidity at the given dehumidifier assembly 200. It is contemplated that the air temperature sensor 292 and the air humidity sensor 294 could be separate from but communicatively connected to the control board 290 in some embodiments. The control board 290 further includes a water temperature sensor 296, in thermal contact with the water spray system 260, for sensing a temperature of water flowing through the water spray system 260. In at least some embodiments, the water temperature sensor 296 could be disposed in the water spray system 260 and communicatively connected to the control board 290. Using information determined by the sensors 292, 294, 296, the control board 290 is configured to determine local humidity conditions and to determine a dehumidification rate needed for the dehumidifier assembly 200 to bring the local humidity conditions in line with a predetermined desired condition or with an instructed condition received from the controller 190. In at least some embodiments, additional water temperature sensors, air temperature sensors and/or humidity sensors could be included and operatively connected to the control board 290. In some such cases, these additional sensors could be used to monitor performance of the assembly 200, determine local energy use, and/or determine other performance data.

The control board 290 is further operatively connected to the fan 215 and the nozzle 264 (specifically a valve (not shown) of the nozzle 264) in order to control activation and operation of the fan 215 and the nozzle 264, in order to cause the dehumidification assembly 200 to modify the local humidity conditions in the area of the greenhouse 10 surrounding the given dehumidifier assembly 200. For instance, the control board 290 may, in some embodiments, control the speed and time of operation of the fan 215. In some cases, the control board 290 may additionally or alternatively control an opening and closing of the valve of the nozzle 264, in order to start or stop delivery of water droplets to the air flowing through the housing 210.

The control board 290 is further communicatively connected to the controller 190. In this way, local conditions from each assembly 200 can be compared and a system level control of the system 100 may be applied, based on different local conditions around one or more of the assemblies 200. For example, the controller 190 could determine that a water temperature of the cold-water supply 160 should be modified. In some cases, determination of temperature adjustment could be based on information gathered from one or more of the dehumidifier assemblies 200. In some embodiments, the controller 190 could provide dehumidification instructions to one or more of the dehumidifier assemblies 200, for instance communicating the predetermined humidity conditions relevant to a given one or more assemblies 200. In at least some cases, it is contemplated that a user of the system 100 could provide or modify desired conditions in one or more subareas of the greenhouse 10 via the controller 190.

In at least some embodiments, it is contemplated that the controller 190 could be omitted from the system 100. In some such cases, operations performed by the controller 190 described herein could be performed by one or more of the control boards 290. For instance, one assembly 200 may have a “primary” control board communicatively connected to the remaining “secondary” control boards. It is also contemplated that the controller 190 and/or one or more of the control boards 290 could be communicatively connected to additional external sensors, including but limited to: CO₂ sensors, solar radiation sensors, light level sensor, and temperature sensors external to the environment 10.

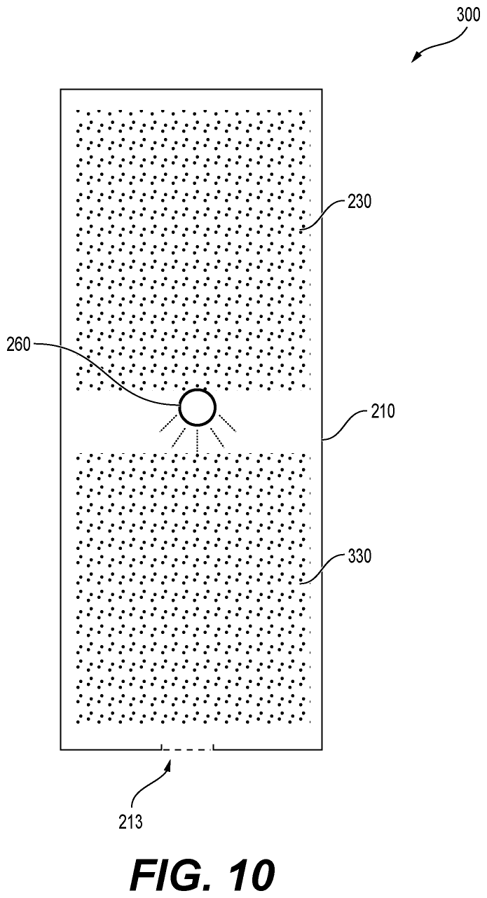

With reference to FIG. 10, another non-limiting embodiment of a dehumidifier assembly 300 is illustrated. Elements of the dehumidifier assembly 300 that are similar to those of the dehumidifier assembly 200 retain the same reference numeral and will generally not be described again.

Different structures are contemplated in the air flow area downstream of the water spray system 260, for example in place of the walls 272 of the assembly 200. In the illustrated dehumidifier assembly 300, a secondary heat exchange core 330 is disposed in a lower portion of the housing 210, with the water spray system 260 being disposed in a generally central position in the assembly 300, vertically between the two cores 230, 330. The secondary core 330 provides a plurality of surfaces for aiding in condensation of moisture from the air flowing downstream of the water spray system 260. Additionally, the secondary heat exchange core 330 could serve, in at least some cases, to aid in heat exchange efficiency of the assembly 200. As will be described below, it is also contemplated that alternative or additional structures, such as textured surfaces, could be used to aid in collection of condensing moisture from the air following the misting portion of the system 260.

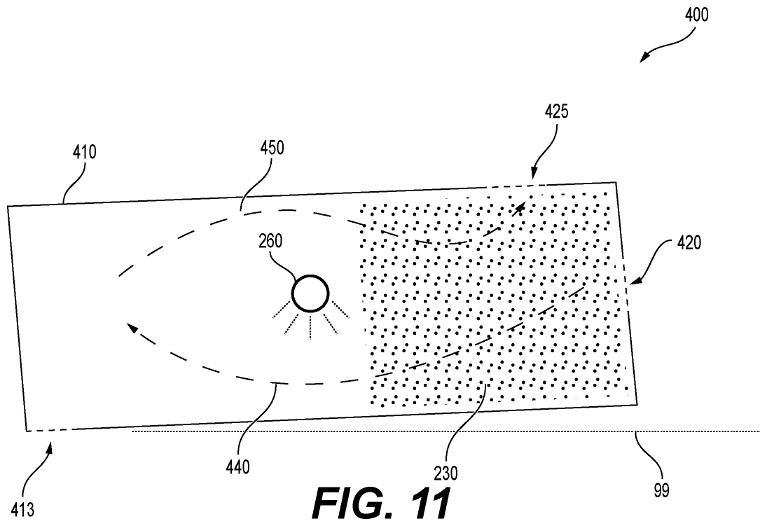

With reference to FIG. 11, another non-limiting embodiment of a dehumidifier assembly 400 is illustrated. Elements of the dehumidifier assembly 400 that are similar to those of the dehumidifier assembly 200 retain the same reference numeral and will generally not be described again.

While the assemblies 200, 300 described above are generally vertically arranged as illustrated, the dehumidifier assembly 400 is a non-limiting example of a differently oriented assembly. The assembly 400 has a generally horizontal housing 410, arranged at a slight angle to true horizontal (represented by the horizontal line 99). An incoming airflow path 440 flows generally right to left, from an air inlet 420, in the arrangement illustrated. An outgoing airflow path 450 flows generally left to right to an air outlet 425. By arranging at a slight angle, water extracted from the humid air flowing into the assembly 400 is encouraged to flow along an interior surface of the housing 410 toward a water collection opening 413. It is noted that an arrangement of an assembly at angles other than vertical or generally horizontal are contemplated without specific limitation. It is also contemplated that the housing 410 could be arranged parallel to horizontal, with at least one wall of the housing 410 being formed to allow for proper drainage of collected water.

Returning to FIGS. 1 and 2 and with additional reference to FIGS. 12A and 12B, overall operation of the dehumidifying system 100 and the dehumidifier assemblies 200 thereof will be described in more detail. The assemblies 300, 400, and the system 105 operate similarly, mutatis mutandis, and will not be described separately.

At each dehumidifier assembly 200, the housing 210, the heat exchange core 230, and the water spray system 260 are arranged such that, when the assembly 200 is in operation, warm and humid air enters the assembly 200 and drier and at least partially warm air is emitted from the assembly 200.

Operation of the assembly 200, in the illustrated embodiment, begins by activating the fan 215, to drive air out of the assembly housing 210, creating a suction within the housing 210 to draw in ambient air surrounding the assembly 200. Warm, humid air flows into the air inlets 220 and into the first airflow path 240 through the heat exchange core 230.

In the heat exchange core 230, heat is transferred from air flowing through the first airflow path 240 to air flowing through the second airflow path 250, thereby cooling air flowing through the first airflow path 240.

Cooled, humid air then flows out of the core 230 from the outlet end 244 of the first airflow path 240 into the lower portion of the housing 210. This cooled air is then impacted by water droplets projected from water spray system 260.

The cold-water droplets provided by the water spray system 260 act to aid in inducing condensation of humidity in the air in at least two manners. First, the cold water further cools the air toward the condensation (dew) point, the air having first been cooled by losing heat through the heat exchange core 230. Second, water droplets suspended in the air provide surface area on which condensation can occur. As is noted above, the temperature of the water supplied to the water spray system 260 by the cold-water supply 130 can be adjusted in at least some embodiments. By adjusting the water temperature at the cold-water supply 130, the dehumidification efficiency of each assembly 200 can be modified. In the present embodiment, linearly decreasing water temperature generally induces a linearly increasing dehumidification rate (in liters of water per hour) within certain temperature ranges. The particular relationship between temperature and dehumidification efficiency is contemplated to vary depending on the specific embodiment.

Moisture condensing out of the air, downstream from the water spray system 260, then generally precipitates from the air and drips down into the lower portions of the housing 210 and flows out of the opening 213 to be collected by the water collection system 110. It is noted that at least some of the water sprayed in water droplets also falls to the bottom portion of the housing 210 and is collected by the water collection system 110.

Subsequently, cooled, dehumidified air flows into the input end 252 of the second airflow path 250 to flow back into and through the heat exchange core 230. Air flowing through the second airflow path 250 receives heat from air flowing through the first airflow path 240 via the heat exchange core 230.

Dehumidified air is thus reheated by heat already present in the air, and more specifically by removing heat from the humid incoming air, which in turn requires cooling as noted above. In this way, the heat exchange core 230 provides a passive cooling of the humid air and reheating of the dehumidified air.

Re-warmed, dehumidified air finally flows out of the air outlet 225 of the housing 210 and back into the environment 10. In the present embodiment, the fan 215 and the cone 217 further aid in directing the dehumidified air away from the inlets 220 and into the environment 10. While the passages in the air exchange core 230 for both the incoming airflow path 240 and the outgoing airflow path 250 are located in proximity to one another, the cone 217 drives outgoing air away from the air inlets 220 of the housing 210 in order to prevent already treated (dehumidified) air from being immediately recaptured by the assembly 200.

In at least some embodiments, it is contemplated that the cone 217, or the housing 210 when the cone 217 is omitted, could be connected to an air duct system (not shown) of the environment 10. For instance, the system 100 could include ducts fluidly connecting the air inlets 220 or the air outlet 225 to a portion of the air duct system.

In addition to dehumidification, it is noted that the use of a cold-water spray/misting by the water spray system 260 also provides some air filtering capabilities. Sometimes referred to as “air washing”, contact of the sprayed water droplets with air born contaminants or particles causes at least some of the particles to be captured in water droplets eventually falling to the bottom of the housing 210, thus removing these impurities from the air. Air born contaminants, debris, or particles suspended in air that could be removed by air washing by the water spray system 260 could include, but are not limited to: dust, pollen, spores, fungus, and smoke particles. It is contemplated that size of the water droplets from the water spray system 260 could be designed at least in part on an efficiency of removing unwanted particles from the air flowing through the assembly 200. In some cases, air filtration by air washing could be improved by reducing water droplet size.

As is noted above, additional cooling is induced by water droplets provided by the cold-water supply 130, via the water spray system 260. As each assembly 200 is connected to one centralized cold-water supply 130, no heat pump or refrigeration equipment to transport away heat is required to be included in or located in proximity to each individual assembly 200. It is noted that the cold-water supply 130 may itself be cooled by a heat pump or refrigeration system in some embodiments. However, there is no specific need for this to be the case, and no heat pump or refrigeration system is required to be integrated or operatively connected to any assembly 200. This allows the system 100 to be formed from many relatively small assemblies 200, with each assembly 200 being generally fairly cost effective.

By providing relatively small dehumidification assemblies 200, operatively connected to one central cold-water supply 130, additional localized control of humidity conditions can also be provided by the present technology. The dehumidifying assemblies 200 are disposed at different points around the greenhouse 10, rather than having one large dehumidification unit in a central location as would often be the case in the prior art. As is further illustrated in FIGS. 12A and 12B, for example, the assemblies 200 are arranged in four rows along a length of the greenhouse 10, with a plurality of rows of planting structures 20, supporting plants 25, extending along a same direction as the rows of assemblies 200. Air is dehumidified and cycled through the greenhouse by the distribution of the assemblies 200, with the distribution and placement of the assemblies 200 being design around the layout of the planting structures 20. As is shown in FIG. 12B, humid air (schematically illustrated in dashed lines) flows through a portion of the greenhouse 10, is treated by a subset of the dehumidifier assemblies 200, and is returned as warm, dry air to the greenhouse 10 to circulate once again (schematically illustrated in solid lines).

As is noted above, local control of the fan 215 and/or water droplet delivery by the water spray system 260 by the control board 290 of each assembly 200 can further be used to provide localized control of humidity conditions. The system 100 thus also provides the possibility of creating microclimates within one given environment 10. Because the large portions of the system 100 are centralized (water supply, handling collected water), the relatively small assemblies 200 can also be dispersed through the environment 10 based on a desired arrangement of microclimate control.

In at least some embodiments and as is mentioned briefly above, it is also contemplated that the controller 190 could be configured to selectively control and communicate with each control board 290 to further provide climate zones or microclimates at different points in the environment 10. For instance, the controller 190 could cause selective activation of the fan 215 of one or more of the assemblies 200 based on overall humidity levels, humidity conditions in a selected portion of the environment 10, and/or based on local readings of one or more of the control boards 290. In at least embodiments, the controller 190 and/or the control board 290 could be configured to provide predetermined humidity conditions based on a variety of conditions, including but not limited to: a type of plant being grown, maturity of the plants, humidity required for additional air treatments, a seasonal condition to be imitated, and energy costs. The controller 190 could further determine an overall humidity trend, based on information received from one or more control boards 290, and then for instance locally activate one or more selected assemblies 200 to change an overall climate/humidity distribution of the environment 10.

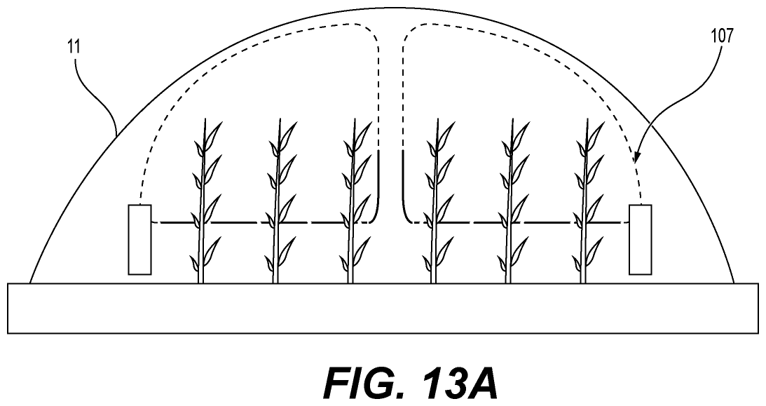

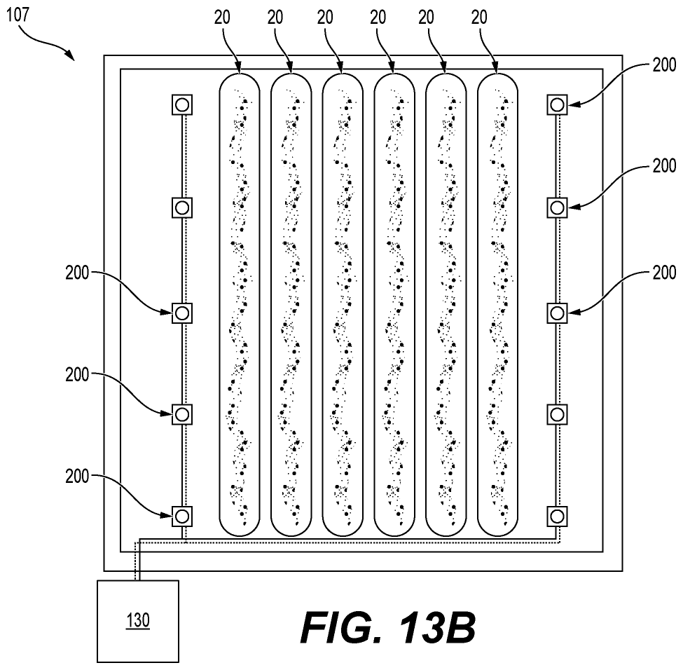

Depending on the distribution of dehumidifier assemblies 200 through the environment, as well as the form and size of the interior environment, the pattern of circulation of humid and dry air could vary. As can be seen in another non-limiting example of a dehumidifying system 107 disposed in a dome-shaped greenhouse 11 illustrated in FIGS. 13A and 13B, the dehumidifying assemblies 200 are disposed along exterior walls.

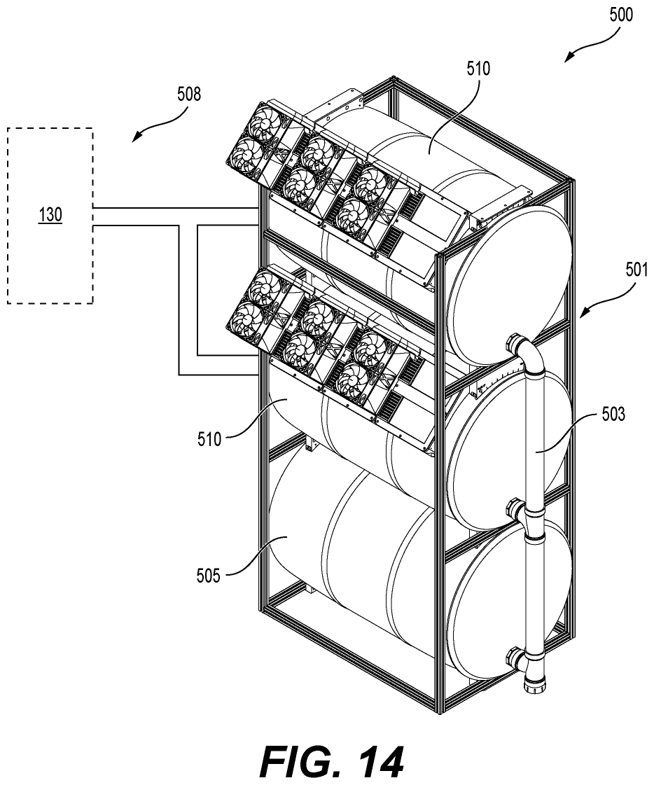

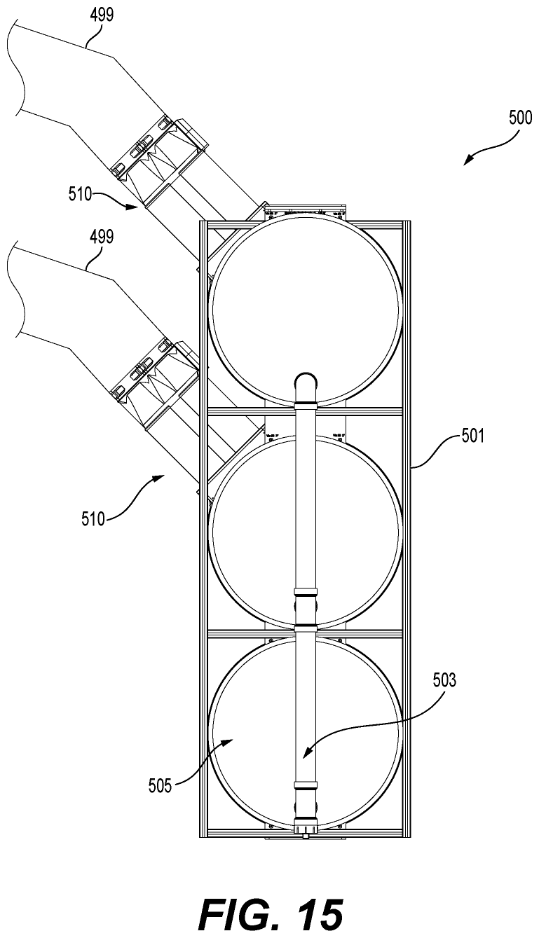

Yet another embodiment of a dehumidifier system 500 having dehumidifier assemblies 550 according to the present technology is illustrated in FIGS. 14 and 15. Elements of the dehumidifier assembly 550 that are similar to those of the dehumidifier assembly 200 will generally not be described again.

In the illustrated embodiment, the system 500 is formed from two dehumidifier structures 510 and a water collection structure 505, each described in more detail below. It is contemplated that different embodiments of dehumidifier systems could include more or fewer dehumidifier structures and water collection structures, including in some instances excluding the water collection structure.

The system 500 includes a frame 501 supporting the dehumidifier structures 510 and the water collection structure 505. While the structures 510, 505 are arranged vertically in the illustrated embodiment, different arrangements are contemplated. As is illustrated in FIG. 15, the system 500 is arranged to be connected to air ducting 499 of a structure (such as a greenhouse) in at least embodiments or installations for delivering humid air to the system 500 for dehumidification thereof. As will be described below, it is also contemplated that the ducting 499 could received dehumidified air from the system 500 in some embodiments. It is also contemplated that the system 500 could be free standing, i.e. not connected to any air ducting, with the system 500 receiving humid air and delivering dehumidified air from its surrounding environment.

In the illustrated embodiment, the water collection structure 505 is specifically a barrel 505, although different containers are contemplated. The system 500 includes water collection tubing 503 fluidly connecting the water collection structure 505 to the dehumidifier structures 510. The tubing 503 and the water collection structure 505 collect water from the dehumidifier structures 510, which includes water from misting as well as water extracted from the air humidity. While not shown explicitly, the water collection structure 505 will generally be connected to a water recycling and/water drainage system to drain water from the structure 505. It is also contemplated that the water collection structure 505 could be connected to a water collection system, such as the water collection system 110 for removing water from system 500. It is further contemplated that the structure 505 could be fluidly connected to a drainage system for expelling the water in some cases. Depending on the embodiment, the structure 505 could be emptied (drained) continuously, periodically, and/or as needed.

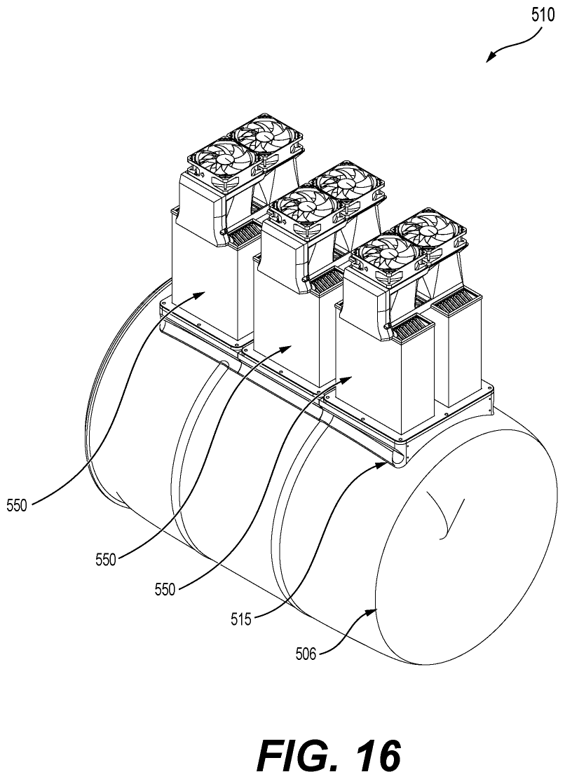

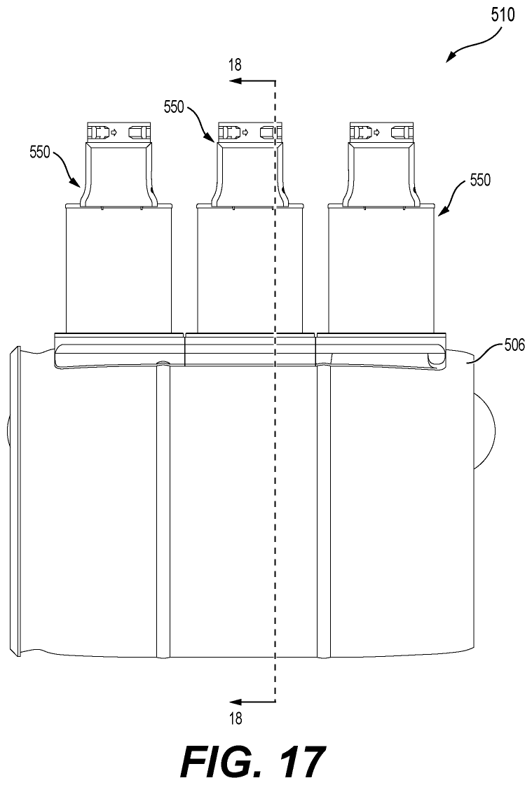

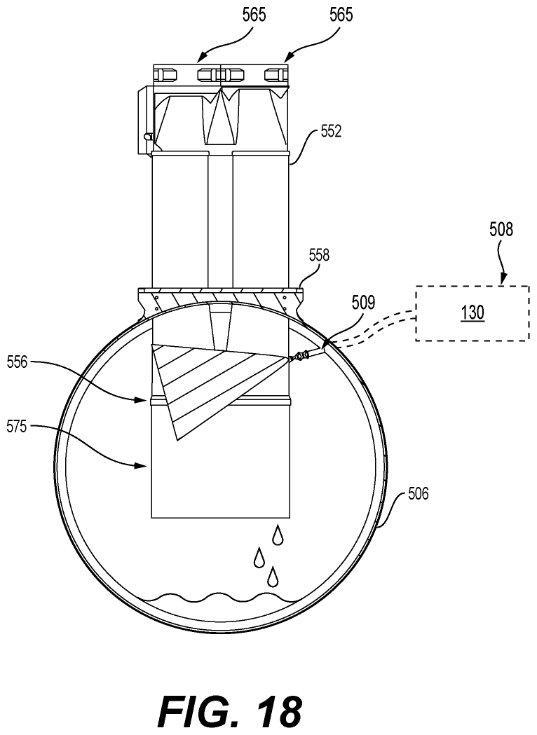

With additional reference to FIGS. 16 to 18, the dehumidifier structure 510 is illustrated is more detail. The structure 510 includes a barrel 506, similar to the water collection barrel 505, although a variety of enclosed structures could be used to form the structure 510. The barrel 506 defines therein an opening 507 for receiving the dehumidifier assemblies 550, shown schematically in FIG. 18.

In the illustrated example, each dehumidifier structure 510 includes three dehumidifier assemblies 550. It is contemplated that the dehumidifier structures 510 could have more or fewer dehumidifier assemblies 550, depending on the embodiment. It is also contemplated that different dehumidifier structures 510 of the same system 500 could have different numbers of dehumidifier assemblies 550.

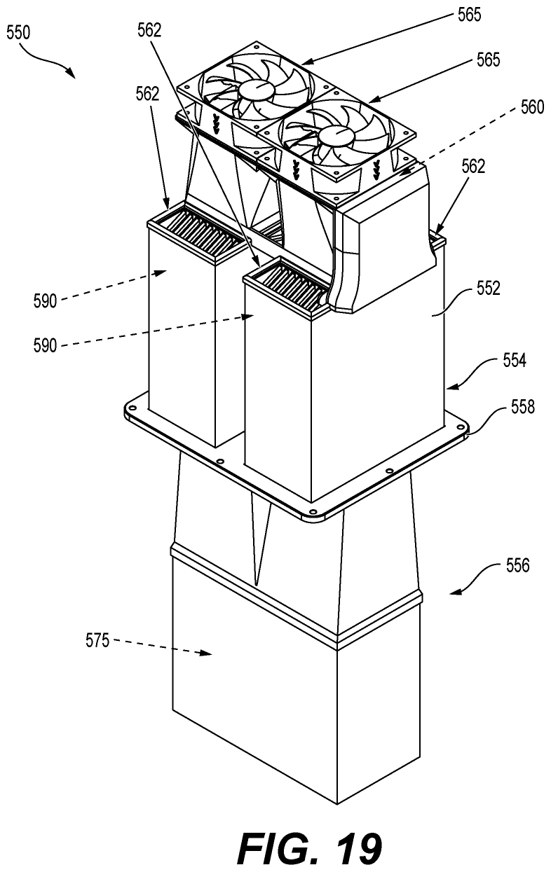

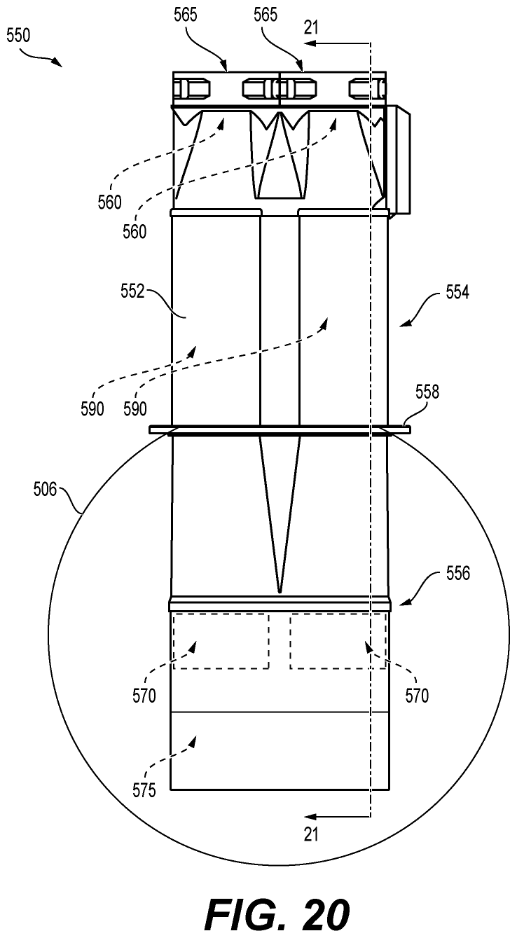

With additional reference to FIGS. 19 to 21, the dehumidifier assemblies 550 are illustrated in more detail. As the assemblies 550 are generally identical through the system 500, only one dehumidifier assembly 550, also referred to as the assembly 550, will be described.

The assembly 550 includes a housing 552 forming the overall shape and exterior of the assembly 550. In the illustrated embodiment, the housing 552 is formed from an upper portion 554, a lower portion 556, and a contour portion 558. The upper portion 554 is split into two portions extending parallel to one another, but it is contemplated that the upper portion 554 could be one continuous portion. The lower portion 556 is similarly separated into two portions, but could be one integrally connected continuous portion in some embodiments.

The contour portion 558 is configured and arranged to connect to the barrel 506. The contour portion 558 is shaped to specifically to close the opening 507, such that air flowing into and out of the barrel 506 must pass through the dehumidifier assemblies 550. While each dehumidifier assembly 550 has a separate contour portion 558 (with portions 558 of neighboring dehumidifier assemblies 500 abutting), it is contemplated that one contour portion sized to close the opening 507 could be used, with remaining portion of a plurality of dehumidifier assemblies 550 connecting thereto.

The upper portion 554 and the lower portion 556 are fastened together via the contour portion 558, but it is contemplated that the portions 554, 556, 558 could be connected together in different manners. It is also contemplated that the portions 554, 556, 558 could be integrally formed in some embodiments.

The upper housing portion 554 defines therein two air inlets 560, one on each lateral part of the upper housing portion 554. The inlet 560 is specifically formed in a top side in the upper housing portion 554 for receiving air from the ducting 499. In the illustrated embodiment, the assembly 550 further includes two fans 565, each being disposed over a corresponding one of the air inlets 560. In some cases, it is also contemplated that an air inlet cone could be connected over the one or both fans 565 in place of the ducting 499. The fans 560 are arranged to draw air into the housing 552, in order to aid in initiation and operation of the assembly 550.

The upper housing portion 554 defines therein four exterior air outlets 562 for air outflow from the assembly 550 and the barrel 506 during operation. The outlets 562 are specifically formed in two lateral sides of the upper housing portion 554. The assembly 550 also includes a second pair of fans 570 for driving air from an interior of the barrel 506 toward the outlets 562. The fans 570 are disposed in the lower housing portion 556, although it is contemplated that the fans 570 could be disposed in a portion of the housing 552 exterior to the barrel 506.

The contour portion 558 defines therein four interior air outlets 559 for air outflow from the assembly 550 to an interior of the barrel 506 during operation. The outlets 559 are specifically formed in two lateral sides of the contour portion 558.

The assembly 550 further includes textured surfaces 575 disposed in a lower part of the lower housing portion 556. The textured surfaces 575 are arranged to provide condensation surfaces to aid in condensing moisture from the air flowing therethrough. A variety of surface forms are contemplated, including but not limited to three-dimensional volumes (such as pyramids or half-sphere bump) extending inward from vertically arranged walls.

Use of the fans 565, 570, textured surfaces 575, and the airflow pattern through the inlets 560 and the outlets 562, 559 will be further described below.

In at least some embodiments, it is contemplated that the fans 565 or the fans 570 could be omitted. It is contemplated that additional flaps, louvers, deflectors, and/or ducting could be included with the housing 552 in some embodiments. For example, deflectors could be included to selectively draw or emit air in a desired direction or position relative to the housing 552.

The assembly 550 includes two heat exchange cores 590, also referred to as the cores 590, disposed at least partially in the upper portion 554 of the housing 552. Similarly to the heat exchange core 230 described above, the heat exchange cores 590 facilitates heat exchange between incoming and outgoing air from the assembly 550. In embodiments where the upper housing portion 554 is not split into two flow sections, it is contemplated that the assembly 550 could include only one core 590.

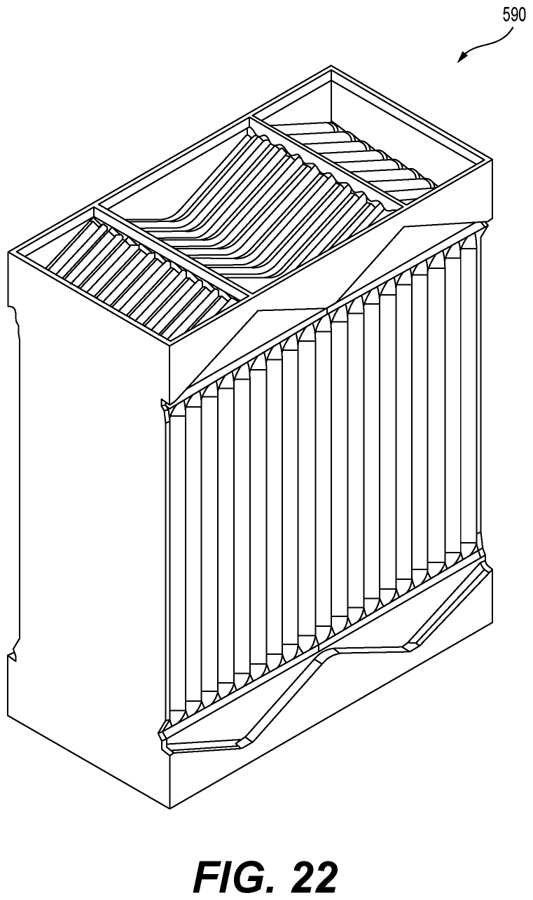

Shown in more detail in FIG. 22, the heat exchange core 590 has a cellular counter-flow geometry, also referred to as cellular counter-current geometry, similar to the heat exchange core 230. In the present embodiment, the heat exchange core 590 is formed by additive manufacturing. In some embodiments, different geometries could be used for the heat exchanger, including but not limited to shapes derived or inspired by biomimetic models (e.g. human lung structures or plant root structures).

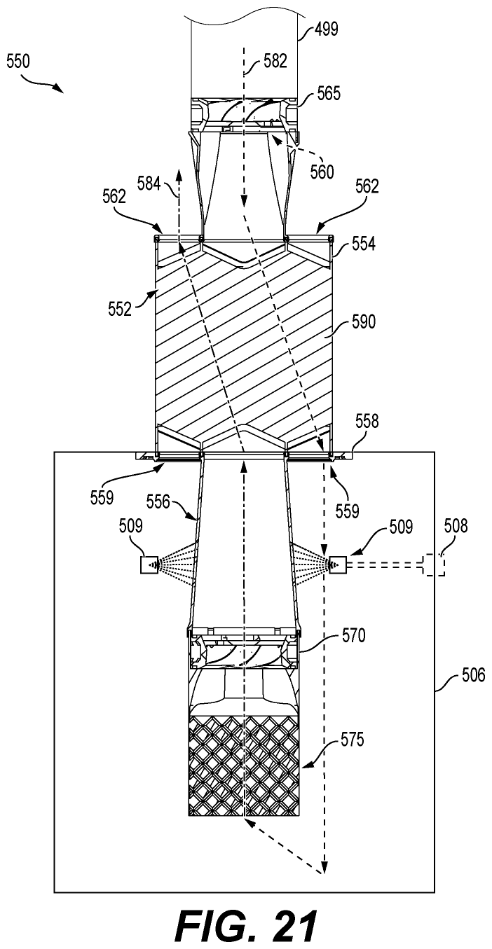

Similarly to the core 230, the cores 590 each define therein two overall counter-flow arranged airflow paths for air to be dehumidified by the dehumidifier structure 510. As is illustrated in FIG. 21, a first airflow path 582 directs air flowing from an exterior of the dehumidifier structure 510, through one of the fans 565 and air inlets 560, into and through the corresponding core 590, and out of one of two interior outlets 559, into an interior volume of the barrel 506. A second airflow path 584 directs air flowing from the space inside the barrel 506 into and through the textured surfaces 575, through one of the fans 570, through the lower housing portion 556, into and through the core 590, and out of the dehumidifier structure 510 via one of the air outlets 563. The fans 565 are arranged to draw air from an exterior of the dehumidifier structure 510 via the first airflow path 582 when in operation. The fans 570 are arranged to draw air from an interior of the barrel 506 into the housing 552 via the textured surfaces 575 via the second airflow path 584. It is noted that only one of a variety of paths 582, 584 have been illustrated. For example, the input path 582 could exit the housing 552 through a different outlet 559 than illustrated. Similarly, the output path 584 could exit through a different outlet 562 than shown in the non-limiting illustration. It is generally contemplated that air will flow along any or all of the different possible paths 582, 584 during operation of the dehumidifier structure 510.

While the housing 552 and the heat exchange core 590 are generally rectangular in the illustrated embodiments, this is simply one example and not meant to be limiting. While the housing 552 is generally shaped to fit close to the core 590, in order to avoid air passing around the core 590 rather than through the airflow paths 582, 584, the core 590 could be manufactured in a variety of forms.

The dehumidifier structure 510 further includes a water spray system 508 disposed at least partially in the barrel 506, similar to the water spray system 260 described above, illustrated schematically in FIGS. 18 and 21. The water spray system 508 is fluidly connected to the cold-water supply 130, although different embodiments of cold-water supplies are contemplated. The water spray system 508 is arranged for delivering water droplets for causing condensation of moisture from air flowing from the first airflow path 582 when the dehumidifier structure 510 is in operation. The water spray system 260 includes at least two spray nozzles 509 disposed at least partially in the barrel 506 for creating the water droplets from the cold-water supply 130, disposed specifically on opposite sides of the lower housing portion 556. It is noted that in contrast to the assembly 200, the nozzles 509 are not disposed within the housing 552.

In the illustrated embodiment, the nozzles 509 are positioned to project water droplets (also referred to herein as mist) in a generally orthogonal to air flowing out of the first airflow path 582, downstream from the cores 590. In some embodiments, the nozzles 509 could be arranged to project water droplets antiparallel to air flow (a counter flow arrangement) and/or parallel to air flow (i.e. concurrent flow arrangement). Subsequent to exposure to the mist from the nozzles 509, air flows through the textured surfaces 575 in order to further aid in condensing humidity from the air. Water condensed from air flow, either during the misting process or upon contact with the textured surfaces 575, then falls to a bottom of the interior volume of the barrel 506. The collected water then flows to the water collection structure 505 via the tubing 503.

Air then flows through the housing 552, now at least partially dehumidified through the misting process and contact with the texture surfaces 575. The fans 570 pull air through and from the textured surfaces 575 into the second airflow path 584, which then passes through the core 590 and out of the outlets 562. Depending on the embodiment, it is contemplated that the fans 565 and/or the fans 570 could be omitted. In some cases for example, air flow through the ducting 499 could be the driving force for airflow through the dehumidifier structure 510.

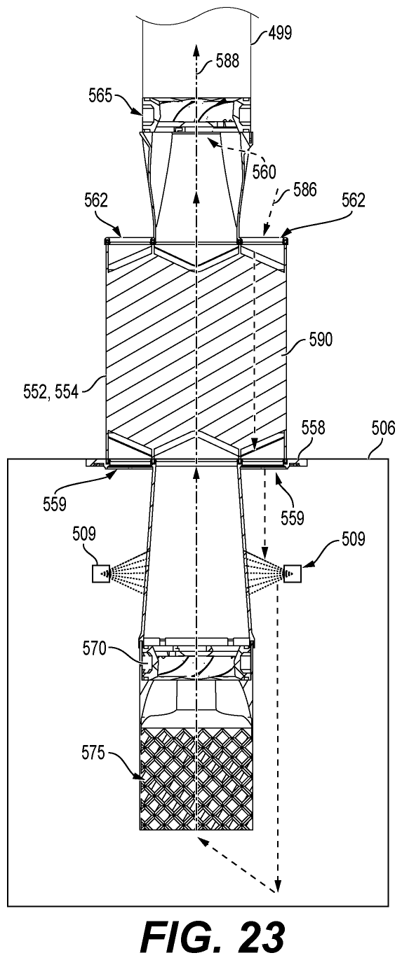

In some embodiments, it is contemplated that operation of the fans 565 could be reversed, thereby modifying the airflow paths through the dehumidifier structure 510. One such non-limiting embodiment is illustrated in FIG. 23, where the flow direction of the fans 565 have been reversed. While the flow direction of the fans 570 could be modified in some embodiments, it is noted that additional modifications of the arrangement of certain components would also need to be modified, as the textured surfaces 575 are generally required to be disposed subsequent to (downstream from) the nozzles 509.

With the fans 565 pulling air from the housing 552, the airflow directions through the “inlets” 560 and the “outlets” 562 are reversed (i.e. air flows into the “outlets” 562 and out of the “inlets” 560); the inlets/outlets 560, 562 may thus be referred to generally as openings 560, 562. A first airflow path 586 directs air flowing from an exterior of the dehumidifier structure 510, into one of the openings 562 and through the corresponding core 590, and out of one of two interior outlets 559, into an interior volume of the barrel 506. A second airflow path 588 directs from the space inside the barrel 506 into and through the textured surfaces 575, through one of the fans 570, through the lower housing portion 556, into and through the core 590, and out of the dehumidifier structure 510 via one of the openings 560 and its corresponding one of the fans 565. The fans 570 are arranged to draw air from an interior of the barrel 506 into the housing 552 via the textured surfaces 575 via the second airflow path 584, with the fans 565 further pulling air from the housing 552 to be expelled to the surroundings of the dehumidifier structure 510.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A dehumidifier assembly for humidity management in an interior environment, the assembly comprising:
a housing defining at least one air inlet and at least one air outlet;
a heat exchange core disposed at least partially in the housing, the heat exchange core defining therein:
a first airflow path fluidly connected to the at least one air inlet at an input end of the first airflow path, and
a second airflow path fluidly connected to the at least one air outlet at an output end of the second airflow path; and
a water spray system disposed at least partially in the housing, the water spray system being configured to be fluidly connected to a cold-water supply,
the water spray system being arranged for delivering water droplets at least partially downstream of an output end of the first airflow path for causing condensation of moisture from air flowing from the first airflow path when the assembly is in use,
the housing and the heat exchange core being arranged such that at least some air downstream of the water spray system flows into an input end of the second airflow path.

2. (canceled)

3. The dehumidifier assembly of claim 1, wherein:
the heat exchange core has a cellular counter-flow geometry;
the first airflow path is formed by a first plurality of passages defined through the heat exchange core; and
the second airflow path is formed by a second plurality of passages defined through the heat exchange core.

4. The dehumidifier assembly of claim 1, wherein:
the housing is configured to be connected to a water collection system to remove water from housing; and
the housing defines at least one opening in a lower portion of the housing, the at least one opening being arranged to be fluidly connected to the water collection system.

5. (canceled)

6. The dehumidifier assembly of claim 1, wherein the water spray system comprises at least one spray nozzle disposed at least partially in the housing.

7. The dehumidifier assembly of claim 6, wherein:
the housing includes at least one separating wall extending generally vertically through a portion of the housing;
the air outlet of the first airflow path and the at least one spray nozzle are disposed on a first side of the at least one separating wall; and
the air inlet of the second airflow path is disposed on a second side of the at least one separating wall.

8. The dehumidifier assembly of claim 1, further comprising a fan disposed in the housing, the fan being arranged to draw air from an interior of the housing from the second airflow path when in use.

9. The dehumidifier assembly of claim 1, wherein the housing, the heat exchange core, and the water spray system are arranged such that, when the apparatus is in use:
warm, humid air flows into the at least one air inlet and into the first airflow path, heat being transferred from air flowing through the first airflow path to air flowing through the second airflow path thereby cooling air flowing through the first airflow path;
cooled, humid air flows out of the first airflow path and is impacted by mist projected from water spray system,
the mist further cooling air flowing past the water spray system and inducing condensation of humidity from said air;
cooled, dehumidified air flows into the input end of the second airflow path to flow through the heat exchange core,
air flowing through the second airflow path receiving heat from air flowing through the first airflow path via the heat exchange core; and
re-warmed, dehumidified air flows out of the at least one air outlet of the housing.

10. The dehumidifier assembly of claim 1, wherein at least a majority of the heat exchange core is disposed vertically above the water spray system.

11. The dehumidifier assembly of claim 1, wherein:
the heat exchange core is a first heat exchange core disposed in an upper portion of the housing; and
the first heat exchange is disposed vertically above the water spray system; and
further comprising a second heat exchange core disposed in a lower portion of the housing, the second heat exchange being disposed below the water spray system.

12. A dehumidifying system for humidity management in an interior environment, the system comprising:
a plurality of dehumidifier assemblies, each dehumidifier assembly comprising:
a housing defining at least one air inlet and at least one air outlet;
a heat exchange core disposed in the housing, the heat exchange core defining therein:
a first airflow path fluidly connected to the at least one air inlet at an input end of the first airflow path, and
a second airflow path fluidly connected to the at least one air outlet at an output end of the second airflow path; and
a water spray system disposed at least partially in the housing, the water spray system being arranged for delivering water droplets at least partially downstream of an output end of the first airflow path for causing condensation of moisture from air flowing from the first airflow path when the assembly is in use,
the water spray system being configured for fluidly connecting to a cold-water supply,
the housing and the heat exchange core being arranged such that at least some air downstream of the water spray system flows into an input end of the second airflow path; and
a water collection system fluidly connected to each dehumidifier assembly for receiving water from each dehumidifier assembly.

13. The dehumidifying system of claim 12, further comprising the cold-water supply fluidly connected to the water spray system of each dehumidifier assembly.

14.-17. (canceled)

18. The dehumidifying system of claim 12, wherein the system is arranged to deliver water collected by the water collection system to at least one planting structure.

19. The dehumidifying system of claim 12, wherein:
the water collection system is formed from a plurality of rigid tubes; and
the plurality of rigid tubes is formed by additive manufacturing.

20.-21. (canceled)

22. A dehumidifier structure for humidity management in an interior environment, the assembly comprising:
a container;
a dehumidifier assembly partially disposed in the container, the dehumidifier assembly comprising:
a housing defining at least one air inlet and at least one air outlet; and
a heat exchange core disposed at least partially in the housing, the heat exchange core defining therein:
a first airflow path fluidly connected to the at least one air inlet at an input end of the first airflow path, and
a second airflow path fluidly connected to the at least one air outlet at an output end of the second airflow path; and
a water spray system disposed at least partially in the container, the water spray system being configured to be fluidly connected to a cold-water supply,
the water spray system being arranged for delivering water droplets at least partially downstream of an output end of the first airflow path for causing condensation of moisture from air flowing from the first airflow path when the assembly is in use,
the housing and the heat exchange core being arranged such that at least some air downstream of the water spray system flows into an input end of the second airflow path.

23. The dehumidifier structure of claim 22, wherein the heat exchange core is formed by additive manufacturing.

24. The dehumidifier structure of claim 22, wherein:
the heat exchange core has a cellular counter-flow geometry;
the first airflow path is formed by a first plurality of passages defined through the heat exchange core; and
the second airflow path is formed by a second plurality of passages defined through the heat exchange core.

25. The dehumidifier structure of claim 22, wherein the container is configured to be connected to a water collection system to remove water from housing.

26. The dehumidifier structure of claim 22, wherein the water spray system comprises at least one spray nozzle disposed at least partially in the container.

27. (canceled)

28. The dehumidifier structure of claim 22, wherein the container, the housing, the heat exchange core, and the water spray system are arranged such that, when the apparatus is in use:
warm, humid air flows into the at least one air inlet and into the first airflow path, heat being transferred from air flowing through the first airflow path to air flowing through the second airflow path thereby cooling air flowing through the first airflow path;
cooled, humid air flows out of the first airflow path and is impacted by mist projected from water spray system,
the mist further cooling air flowing past the water spray system and inducing condensation of humidity from said air;
cooled, dehumidified air flows into the input end of the second airflow path to flow through the heat exchange core,
air flowing through the second airflow path receiving heat from air flowing through the first airflow path via the heat exchange core; and
re-warmed, dehumidified air flows out of the at least one air outlet of the housing.

29. A dehumidifier system comprising:
at least one dehumidifier structure according to claim 22; and
at least one water collection structure fluidly connected to the water collection structure.
